(19) United States
(12) Patent Application Publication
(10) Pub. No.: US 2011/0220008 A1
(43) Pub. Date: Sep. 15, 2011

(54) Bookmark

(76) Inventor: Kenji Kamiya, Saratoga, CA (US)

(21) Appl. No.: 12/659,418

(22) Filed: Mar. 9, 2010

(51) Int. Cl. B42D 9/00

(52) U.S. Cl. 116/237

(57) ABSTRACT

A Γ-shape bookmark is made from a sheet of transparent, flexible and resilient materials, or from a combination of such materials and non-transparent materials. A body plate V goes in a book. A hook I is for hanging the bookmark on the top end against the spine of the book. A margin area A above the body plate V is for displaying texts and/or images. A transparent page-holder S allows secure holding of an opened page without blocking the reader's view of the texts. The outer edge J of the page-holder S may be slanted inward, while the inner edge Z outward. The edge P of the plate V may either have teeth Xₙ, Yₙ, etc., or may be sandwiched by two narrow strips of high friction material. Holes Rₙ allow the bookmark to be installed in a binder. A barcode, mosaic code or IC chip allows electronic data processing.

### BACKGROUND OF THE INVENTION

### Field of the Invention and Related Art Statement

The present invention relates to a bookmark that will automatically mark a newly opened page as the reader progressively turns the pages, and will offer simplicity of installation and use, and durability that resolve the flaws and shortcomings in the prior inventions of the similar kinds, advertising capability and electronic data communications.

The bookmarks have probably been with us ever since the book was invented, and a variety of them have been invented. The principal purpose of the bookmark is to find the page the reader left off. The simplest is a small piece of paper or a vertically long rectangular card. However, such type of bookmark is inconvenient because it has to be manually removed from the page while reading, and put back when suspending reading. And it's often forgotten to be put back on the page if the reading is abruptly interrupted.

There are several prior inventions of bookmarks that allow automatic bookmarking such as by William (GB Patent No. 190307312), by May (U.S. Pat. No. 6,015,166), and by Hawkins (U.S. Pat. No. 3,697,100).

### OBJECT OF THE INVENTION

However, each of those inventions has applicational and functional limitations, and possible problems under long-term use and wear.

For instance, the key members of the GB Patent No. 190307312 consist of the tongue b for clipping the bookmark to a book, the spring piece c for holding down the leaf-holder d which holds down a newly opened page. However, the tongue b and the leaf-holder d can easily break off under long term use, because a linear or right-angle cut can be eventually torn by repetitive bending motion. Further, although the merit of the narrow leaf-holder d is to avoid covering the texts on the current page, its downside is that the pages which are pressed down by the leaf-holder d may get loose and escape from the leaf-holder d because the tongue b may not be able to continue securing the bookmark tightly, especially when it breaks off.

The purpose of the invention of the U.S. Pat. No. 6,015,166 is strictly to hold the finished pages under the marker 2 by manually raising the marker 2 and sliding the finished pages under it. This invention has a critical problem as follows. When the reader finishes reading the right-side page and turns it to the left, the newly opened left-side page is the very page the reader has to read. However, the marker 2, depending on its length, can block the view of the text.

The U.S. Pat. No. 3,697,100 is a simple and effective bookmarking device. However, it is not reusable for reading another book because the mounting arms must be glued to the book to be read, and the gluing operation requires the user's extra attention so as not to misalign it with the book. Further, in case the user needs to remove such device, the book may be damaged.

The purpose of the present invention is to resolve such problems and shortcomings of the prior automatic bookmarking devices described above. More specifically, the purposes of the present invention are to simplify the installation procedure, to reduce the need of removing the bookmark while reading, to make a text/image messages such as commercial advertisement, etc. on the bookmark to be always visible to the reader, and to incorporate a barcode, mosaic code or chip for electronic data transaction use.

### SUMMARY OF THE INVENTION

The bookmark of the present invention employs a transparent, flexible and resilient sheet of materials, or a combination of such materials and non-transparent and resilient materials, for the purpose of offering a most convenient bookmark with a capability of advertisement, or the like. The transparency prevents the page-holding member of the bookmark from blocking the reader's view of the texts; and the flexibility and resiliency of the arm provides a light spring effect for press-holding the opened page.

As described further in detail below, the unique shape and physical treatment of the bookmark offer more durability, easy handling, a message space such as for commercial advertisement, etc.

### BRIEF DESCRIPTION OF THE DRAWINGS

FIG. 1.1 A front view showing an embodiment of the present invention.

FIG. 1.2 A side view showing an embodiment of the present invention.

FIG. 1.3 A bottom view showing an embodiment of the present invention.

FIG. 1.4 A bottom view showing another embodiment of the present invention.

FIG. 1.5 A bottom view showing another embodiment of the present invention.

FIG. 2 A perspective view showing an embodiment of the present invention installed on a book.

FIG. 3 A perspective view showing an embodiment of the present invention installed on a book.

FIG. 4.1 A partial front view showing an embodiment of the present invention.

FIG. 4.2 A partial side view showing an embodiment of the present invention.

FIG. 4.3 A partial bottom view showing an embodiment of the present invention.

FIG. 5.1 A partial front view showing an embodiment of the present invention.

FIG. 5.2 A partial side view showing an embodiment of the present invention.

FIG. 5.3 A partial bottom view showing an embodiment of the present invention.

FIG. 6.1 A partial front view showing an embodiment of the present invention.

FIG. 6.2 A partial side view showing an embodiment of the present invention.

FIG. 6.3 A partial bottom view showing an embodiment of the present invention.

FIG. 7.1 A partial front view showing an embodiment of the present invention.

FIG. 7.2 A partial front view showing an embodiment of the present invention.

FIG. 7.3 A partial front view showing an embodiment of the present invention.

### DETAILED DESCRIPTION OF THE INVENTION

Reference now should be made to the drawings in comparing the present invention with the prior inventions.

Most of the previously invented bookmarks are either simple to install but cumbersome to handle during and after reading, or easy to handle while reading but rather cumbersome to install. For instance, the bookmark of the GB Patent No. 190307312 is secured to a book by clipping the tongue b to the back cover of the book. This creates two major problems as follows. As the tongue b cannot always steadily secure the spring piece c, which should be in parallel with the top edge of the book, and thus the horizontally narrow shape of the leaf-holder d, whose purpose is to avoid covering part of texts of the page to read, tends to sway upward and slip off the book as the reader progressively turns the pages. Therefore, the reader may have to reposition the leaf-holder d frequently. This problem contradicts with the primary purpose intended by the GB Patent No. 190307312. Further, the tongue b can be torn apart from the main body of the bookmark under repetitive use. Also, the leaf-holder d can be torn apart from the spring c as it will be raised repeatedly. Because, any linear cut in a sheet of materials tends to be torn by repetitive pulling motion.

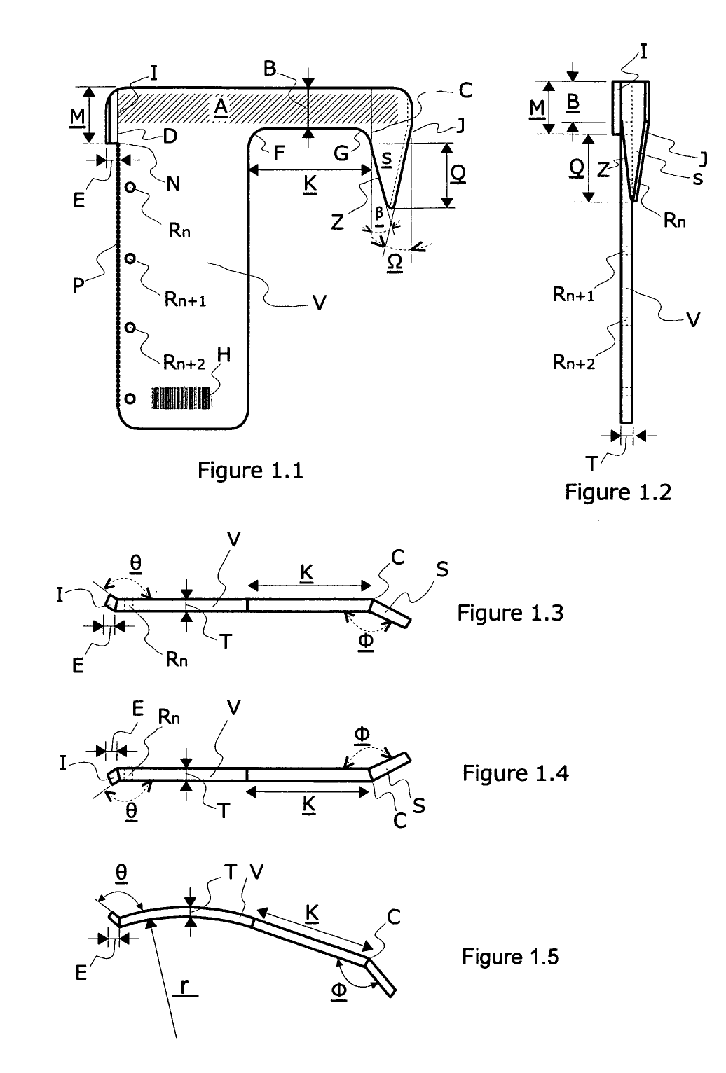

In FIG. 1.1 showing the principal aspects of the present invention, the bookmark is made by stamping, cutting or molding a thin sheet of transparent, flexible and resilient materials, or by combination of such materials and a non-transparent and resilient materials.

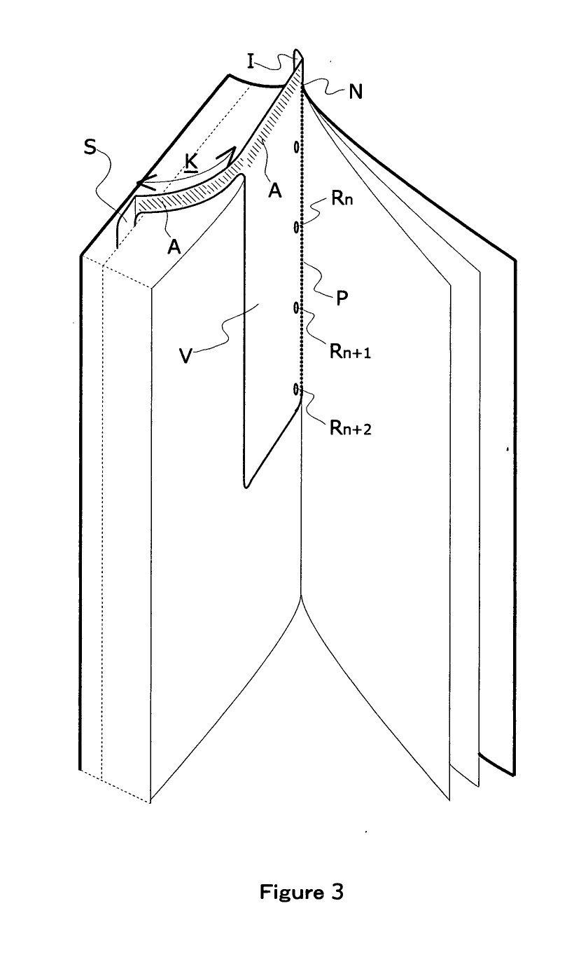

Installation of the bookmark is as simple and secure as described in the following. An optimal location for the bookmark to be installed is not directly inside the back cover but several pages before, because the tightly bound content pages along the spine of the book help the bookmark be tightly compressed and secured. If the book is considerably thick, it is more reasonable to install the bookmark in a more forward range of the book. As the bookmark is slid downward from top, the hook I catches the top edge of the spine of the book by the recessed right-angle corner N, and the edge P of the body plate V is pushed in toward the spine of the book, as shown in FIG. 3. As the hook I is horizontally bent, either forward or backward, along the line D at a certain angle φ, it ensures that the hook I will sit on top of the plane formed by a sheaf of the pages. When the angle φ is 90°, the hook functions optimally effectively.

Unless the angle φ is 90°, the width E between the edge P and the farthest left edge of the top margin, as represented by M, of the bookmark should be empirically optimized such that when the book is closed, the bookmark will not be interfered by the back of a hard cover book, which is taller than the sheaf of the pages.

The recessed right-angle corner N and the edge P guarantee that the top portion M of the bookmark will be positioned above the book, and the top edge of the bookmark is in parallel with the top edge of the book. The vertical position of the recessed right-angle corner N, as represented by M, may be at or below the bottom of the curves F and G to prevent irregular force incurred by the arm K when the page-holder S is placed on the page.

The page-holder S is bent at an angle ø along the line C, as shown in FIGS. 1.2, 1.3 and 1.4. This bend will allow the page-holder S to press the page more squarely and firmly than not being bent, and will prevent the outer edge J of the page-holder S from protruding awkwardly above the surface of the opened page. The angle ø may be empirically optimized. However, the page-holder S can function properly without this bent.

The outer edge J of the page-holder S may be slanted inward at an angle Ω, as shown in FIGS. 1.1, 1.2 and 2, for allowing smoother page-turning operation. The edge J may not have to be slanted for the page-holder S to function properly. The angle Ω may be empirically determined to be optimal. If it's too extensive, the page-holder S may become too weak to hold the page firmly.

The inner edge Z of the page-holder S may be slanted outward at an angle β, as shown in FIGS. 1.1 and 2, for allowing smoother page-turning operation. The edge Z may not have to be slanted for the page-holder S to function properly. The angle β may be empirically determined to be optimal. If it's too large, the page-holder S may become too weak to hold the page firmly.

FIGS. 1.1, 7.1, 7.2 and 7.3 show four combinations of preferred embodiment of the edges J and Z of the page-holder S.

In FIG. 1.4, the page-holder S and the hook I are respectively bent in the opposite directions of the case shown in FIGS. 1.1, 1.2 and 1.3. This is to adapt the bookmark of the present invention to the countries where the paging order may be reversed in comparison with the western style book. In such situation, the configuration of the bookmark of the present invention can be based on FIG. 1.4 and flipped when installing in such a book so that it will function the same way as with the western style book.

FIG. 1.5 shows another preferred embodiment of configuring the body plate V, wherein the body plate V is curved forward horizontally at radius r for the purpose of aligning the body plate to the curved pages when the book is opened. This curve further prevents the bookmark of the present invention from slipping out of the book easily. In the case of adapting the bookmark of the present invention to the book whose page order is reversed, the body plate V may be curved backward horizontally.

The corners F and G may simply be in a right-angled shape. However, because the page-holder S may be frequently lifted up, pulled or twisted by the reader, the right-angled corners tend to tear apart under long-term use. On the other hand, the circular shaped corners make it more durable against tear.

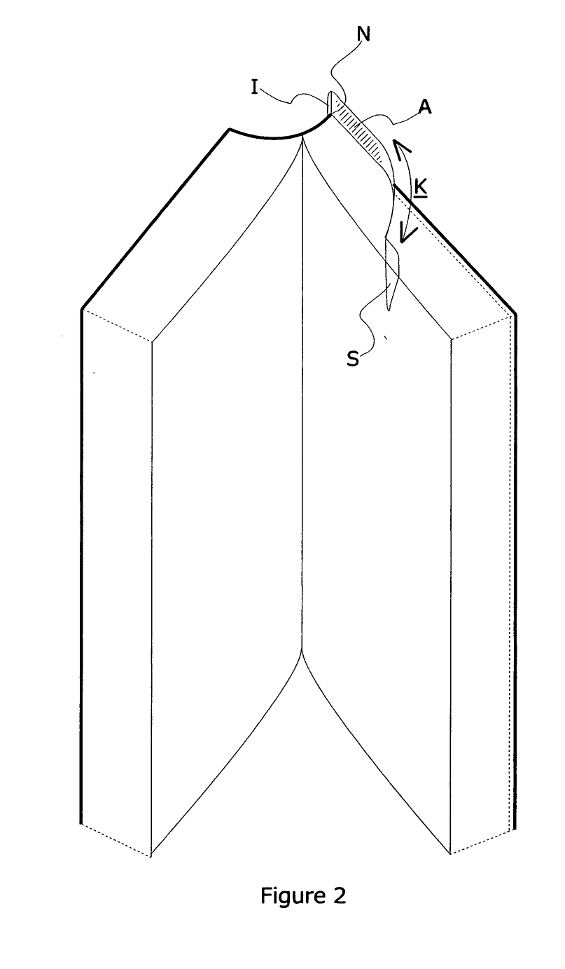

The section represented by Q of the page-holder S sits on the top-right surface of the opened page, as shown in FIG. 2. The length of the section represented by Q may be empirically optimized. If it's too long, it hinders page-turning operation; if too short, the page-holder S may easily slip off the page. An advantage of the present invention is that the page-holder S is transparent such that the texts will be seen through even in the case the page-holder S may partially cover the text area.

In the figures shown in here, the bookmark plates may seem relatively thicker than realistic for the purpose of clearly describing the present invention. In reality the thickness T may vary depending on the size of the bookmark of the present invention.

While the thickness T is empirically determined to be thin enough to allow the bookmark to be securely installed in the book, an additional advantage of the present invention is provided by the treatment of the edge P of the body plate V for the purpose of allowing the bookmark to settle in the book easily and more securely.

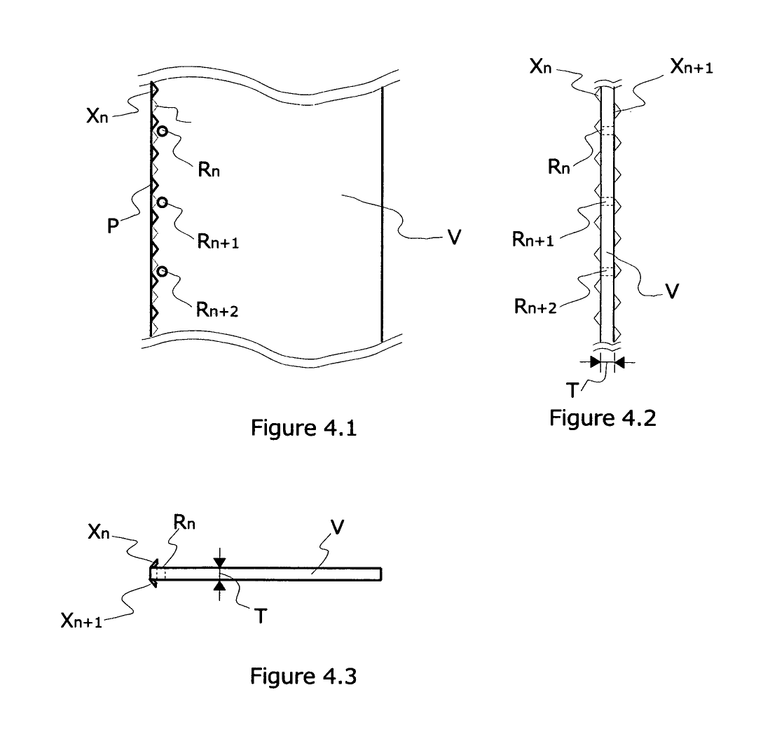

FIGS. 4.1, 4.2 and 4.3 show one such preferred embodiment, wherein a plurality of small triangular shaped teeth Xₙ are formed along the edge P. The teeth Xₙ may be made by molding, or by cutting the edge P and bending them alternately in the opposite directions of each other in an empirically optimized angle, as shown in FIGS. 4.2 and 4.3. The size of the teeth Xₙ may be as small as they would not be easily damaged in insertion/removal of the bookmark. When the edge P with such teeth Xₙ is inserted toward the spine of the book between the opened pages as shown in FIG. 3 and then open another page to read, as shown in FIG. 2, the binding force along the spine of the book compresses and securely holds the body plate V in place. When the page is opened again, the teeth Xₙ will be released, thereby the bookmark will be easily removed.

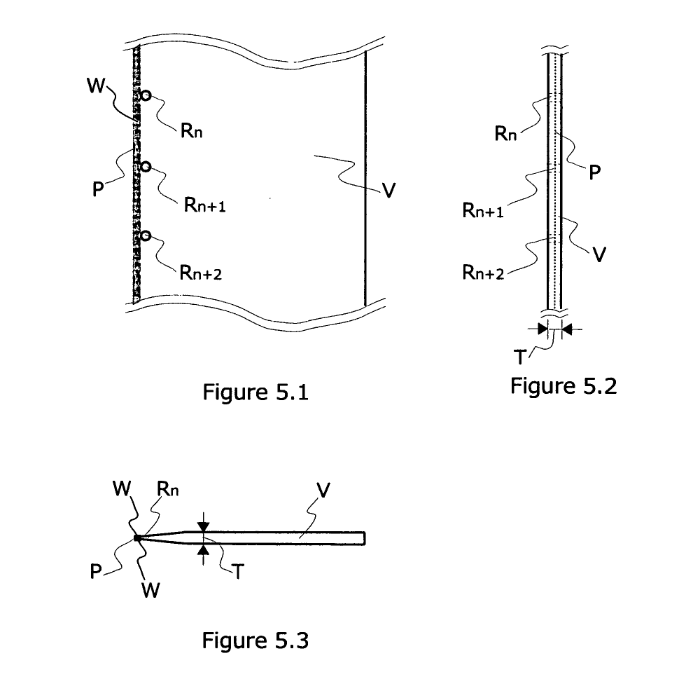

FIGS. 5.1, 5.2 and 5.3 show another preferred embodiment of treatment of the edge P, wherein the edge P may be tapered, as shown in FIG. 5.3, and one or both of its sides be coated with a thin and narrow strip W of rough surface, paper, corduroy type cloth or semi-adhesive material, as shown in FIGS. 5.1 and 5.2. This rough or sticky surface of the strip W of a high friction coefficient will enhance the holding of the bookmark in place. The edge P may not have to be tapered because the body plate V may be already thin enough to be able to accommodate extra strips W with no hindrance.

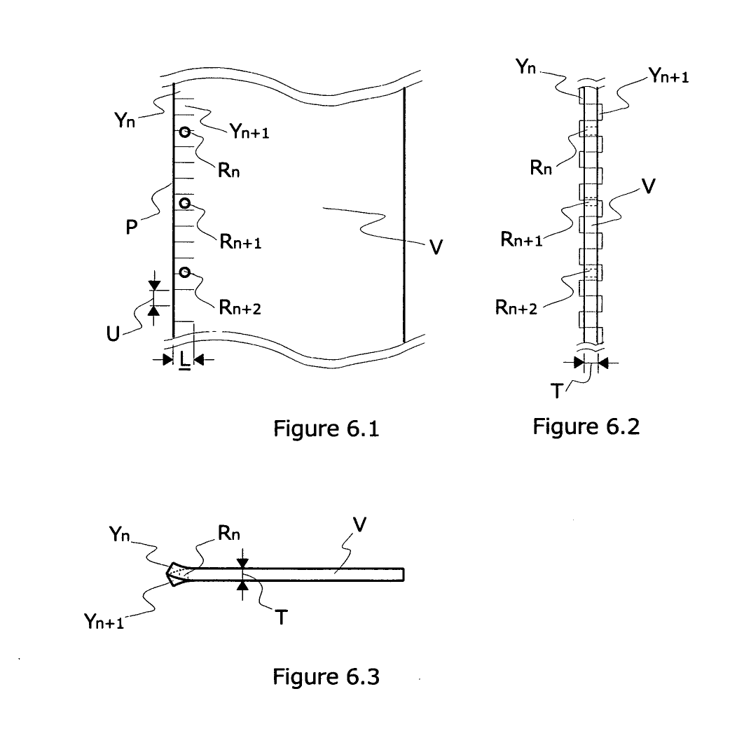

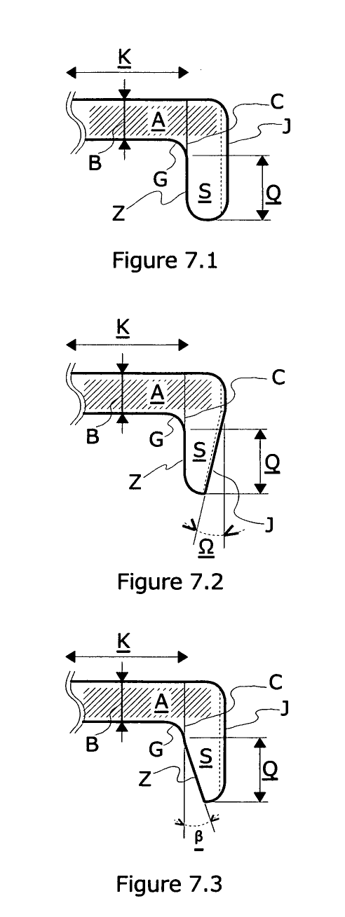

FIGS. 6.1, 6.2 and 6.3 show yet another preferred embodiment of treatment of the edge P, wherein a plurality of small rectangular shaped teeth Yₙ are created along the edge P. The teeth Yₙ may be made by molding, or by cutting the edge P and bending them alternately in the opposite directions at an empirically optimized angle, as shown in FIGS. 6.2 and 6.3. The length L and the width U of the teeth Yₙ may be empirically optimized such that they would not be easily damaged in insertion/removal of the bookmark while generating enough isometric force against the binding force of the pages along the spine of the book to secure itself when the bookmark is settled in the book as shown in FIG. 2.

Although only three enhancement means for securing the bookmark in the book are described here, other similar means can be easily implemented based on the concept of the present invention described herein.

The binder holes Rₙ are for applying the bookmark in a binder. The positions of the binder holes Rₙ may conform to the industry standard.

Area A, as indicated in FIGS. 1.1, 2 and 3, is suitable for image/text messages such as a commercial advertisement, etc., as it is always visible to the reader's eye above the page. Although the surfaces of the body plate V are mostly not as visible as the area A to the reader, they may be suitable for putting additional information regarding the advertisement shown in the area A.

The barcode H may be uses for electronic data processing such as commercial transactions. Although only barcode is described here, other devices for electronic communication, such as the Mosaic pattern code, the IC chip, etc., may be applied.

It will be appreciated by those of ordinary skill in the art that further modifications to and variations of the above-described may be made without departing from the inventive concepts disclosed herein. Accordingly, the invention should not be viewed as limited except as by the scope and spirit of the appended claims.

### GLOSSARY

A: area for possible advertisement
B: width of the arm K
C: bending line between the arm K and the page-holder S
D: bending line between the body plate V and the hook I
E: depth of the recessed right-angle corner N
F: one end corner of the arm K
G: one end corner of the arm K
H: barcode
I: hook
J: slanted outer edge of the page-holder S
K: flexible and resilient arm
L: length of the teeth in FIG. 6.1
M: height of the top margin of the bookmark, exposed above.
N: recessed right-angle corner
P: outer edge of the body plate V
Q: section of the page-holder S
Rₙ binder holes
S: page-holder
T: thickness of the bookmark plate
U: width of the teeth Yₙ in FIG. 6
V: body plate
W: thin and narrow strip of fine particles, paper or corduroy type cloth
Xₙ: teeth
Yₙ: teeth in FIG. 6
Z: slanted inner edge of the page-holder S
ø: angle between the page-holder S and the arm K
φ: angle between the hook H and the top margin M of the bookmark
Ω: angle between the edge J of the page-holder S and vertical line
β: angle between the edge Z of the page-holder sS and vertical line

What is claimed is:

1. A bookmark made from a sheet of flexible, resilient transparent materials, or with a combination of said flexible, resilient and transparent materials and non-transparent and resilient materials, comprising:
a body plate of a predetermined size and thinness, characterized in that said body plate is inserted in a book;
a margin area of a certain width extending upward from said body plate area to form the top area of said bookmark plate for displaying images and/or text messages;
a hook area protruding slightly to the left of said margin area, forming a recessed right-angle corner between the lower edge of said hook area and said body plate, characterized in that said hook rests on the top end of the spine of a book;
a flexible and resilient arm of a predetermined width and length, extending in the right direction from said margin area, characterized in that said arm presses an opened page moderately; and
a transparent, flexible and resilient page-holder of a predetermined width extending vertically downward from said flexible and resilient arm by empirically optimized length, characterized in that said transparent page-holder holds down said opened page securely without obstructing a reader's view of the texts on said page.

2. The bookmark of claim 1, wherein:
the lower corner of the joint between said body plate and said flexible and resilient arm is in a partial circular shape,
the lower corner of the joint between said flexible and resilient arm and said page-holder is in a partial circular shape.

3. The bookmark of claim 1, wherein:
a plurality of a predetermined shapes are uniformly formed alternately in two opposite directions along the left edge of said body plate, characterized in that said shapes allows said bookmark more securely to cling to said book in its spine area.

4. The bookmark of claim 1, wherein:
narrow and thin strips of rough or temporarily adhesive surface, or the like, are adhered on one side or both sides along said left edge of said body plate, characterized in that said strips allows said bookmark to cling more securely to said book in its spine area.

5. The bookmark of claim 1, wherein:
said left edge of said body plate is tapered.

6. The bookmark of claim 1, wherein:
said margin area and said flexible and resilient arm are wide enough for accommodating a space for conspicuously putting text messages and/or images.

7. The bookmark of claim 1, wherein:
electronic data transaction media, such as a barcode, mosaic code, IC chip, etc. are integrated.

8. The bookmark of claim 1, wherein:
at least one small hole is formed slightly inside along said left edge for allowing said bookmark to be mounted in a binder.

9. The bookmark of claim 1, wherein:
said transparent, flexible and resilient page-holder is bent horizontally, either forward or backward, at a predetermined angle along the vertical line of the inner edge of said page-holder, characterized in that said page-holder enhances the page-holding ability of said bookmark.

10. The bookmark of claim 1, wherein:
the outer edge of said transparent, flexible and resilient page-holder is slanted inward at a predetermined angle, characterized in that said slanted edge allows smoother page turning.

11. The bookmark of claim 1, wherein:
The inner edge of said transparent, flexible and resilient page-holder is slanted outward at a predetermined angle, characterized in that said slanted edge allows smoother page turning.

12. The bookmark of claim 1, wherein:
The outer edge of said transparent, flexible and resilient page-holder is slanted inward at a predetermined angle, characterized in that said slanted edge allows smoother page turning, and
The inner edge of said transparent, flexible and resilient page-holder is slanted outward at a predetermined angle, characterized in that said slanted edge allows smoother page turning.

13. The bookmark of claim 1, wherein:
said hook is bent horizontally, either forward or backward, at a predetermined angle along the vertical line of the left edge of said body plate, characterized in that said bent hook ensures that said bookmark is hung on the top end of the spine of said book.
